(19) United States
(12) Patent Application Publication
(10) Pub. No.: US 2013/0197981 A1
(43) Pub. Date: Aug. 1, 2013

(54) SYSTEM AND APPARATUS FOR PROVISIONING SERVICES IN AN EVENT VENUE

(71) Applicant: 2301362 ONTARIO LIMITED, Blair (CA)

(72) Inventor: Robert Erminio Vernon Vendetti, Blair (CA)

(73) Assignee: 2301362 ONTARIO LIMITED, Blair (CA)

(21) Appl. No.: 13/750,142

(22) Filed: Jan. 25, 2013

Related U.S. Application Data
(60) Provisional application No. 61/591,507, filed on Jan. 27, 2012.

(51) Int. Cl. H04W 4/04

(52) U.S. Cl. CPC H04W 4/043
USPC 705/14.5; 455/456.3

(57) ABSTRACT

The embodiments described herein relate systems and methods for providing concierge services at event venues hosting live performances. The system include a server configured to receive real-time performance information indicative of a current status of a live performance at an event venue having a plurality of seats; and a plurality of concierge devices in data communication with the server, each of the concierge devices being coupled to one of the plurality of seats, having an input device for receiving input from an attendee at the live performance, and being associated with location information indicative of a location of the seat. The server and the concierge devices are configured to provide a plurality of event-venue related services at the concierge devices, the event-venue related services being selectable based upon input from the attendee, and at least one of the event-venue related services provided comprise displaying supplemental information at the concierge devices based upon the location information associated therewith, the supplemental information being based upon the real-time performance information.

### TECHNICAL FIELD

The embodiments described herein relate to systems and devices for provisioning services, and in particular to systems and devices for provisioning services in event venues.

### INTRODUCTION

Event venues such as stadiums, concert halls, and conference centres host a large number of spectators attending various live performances. The operators of such venues are generally concerned about the experiences of the spectators attending such events as well as about increasing revenue from the events.

The operators may provide various value added services to the spectators attending the event. These services may improve spectator experience and/or increase revenue for the event venue operator. For example, many venues have concession stands to sell food and beverages for consumption during the performance. Many venues also sell programs about the live performance to provide background information and/or other relevant information about the event such as statistics for sports teams or players. Similarly, they may also sell merchandise related to the performance. In addition to selling various items to raise revenues, the operators may also raise revenue from corporate sponsors through placement of corporate advertisements.

Generally, costs of tickets to attend various events may be tiered. The event venues may be particularly concerned about providing superior spectator experience to the spectators who had purchased more expensive tickets. In some cases, the event venues may be concerned with providing superior spectator experience to the most loyal or most frequent spectators such as season-ticket holders for sports teams. Traditionally, the event venue may set up a dedicated telephone line for such customers to call in and manage their accounts. In some cases, the event venue might offer waiter service to individuals seating at certain (e.g. more expensive) seats. However, providing such services come at a cost to the operators. Furthermore, the operators may wish to provide new services that may increase spectator satisfaction, particularly to selected groups of spectators.

Accordingly, there is a need for an improved system and apparatus for provisioning services in an event venue.

### SUMMARY

According to some aspects, there is provided an in-venue concierge system including a server configured to receive real-time performance information indicative of a current status of a live performance at an event venue having a plurality of seats; and a plurality of concierge devices in data communication with the server. Each of the concierge devices is coupled to one of the plurality of seats, has an input device for receiving input from an attendee at the live performance, and is associated with location information indicative of a location of the seat. The server and the concierge devices are configured to provide a plurality of event-venue related services at the concierge devices. The event-venue related services are selectable based upon input from the attendee and at least one of the event-venue related services provided include displaying supplemental information at the concierge devices based upon the location information associated with the device. The supplemental information is based upon the real-time performance information.

In some aspects, the supplemental information displayed includes at least one message from a personnel associated with the live performance.

In some aspects, the at least one message is recorded during the performance.

In some aspects, the at least one message is displayed at the concierge devices in real-time.

In some aspects, the at least one message is displayed at selected concierge devices, the devices being selected based upon the location information associated therewith.

In some aspects, the supplemental information provided at the concierge devices is differentiated based upon location information associated with the devices.

In some aspects, the supplemental information provided at the concierge devices is differentiated based upon real-time performance information.

In some aspects, the supplemental information includes advertising.

In some aspects, the supplemental information includes a media broadcast of the live performance.

In some aspects, the supplemental information includes accessibility information to promote access to the live performance.

In some aspects, the input device is operable to solicit input from the attendee based upon the current status of the live performance.

In some aspects, the input device is operable to solicit input from the attendee on-demand.

In some aspects, the received input is associated with the location information of the concierge device from which the input is received.

In some aspects, the event-venue related services include receiving at least one order for a product or a service, the received order being associated with the location information of the concierge device from which the order is received.

In some aspects, event-venue related services include accepting payment from a user.

In some aspects, at least one of the concierge devices includes a wireless communication device for communicating with a portable electronic device.

In some aspects, at least one of the seats include a headrest and one of the concierge devices is mounted to the headrest.

In some aspects, the system further includes mounting hardware for coupling the concierge device to one of a plurality of seats in the event venue.

In some aspects, the concierge device includes a display and the mounting hardware includes an adjustable mechanism to adjust an angle of the display device.

In some aspects, the server is further configured to track usage information of at least one of the concierge devices and associate that usage information with at least one of the real-time performance information and the location information.

According to some other aspects, there is provided an electronic concierge device including an electronic display, an input device for receiving input from a user, a communication device, a processor coupled to the electronic display, input device and the communication device. The processor has location information associated therewith that is indicative of a location of the concierge device. The processor is configured to communicate with a server via the communication device, the server having real-time performance information indicative of a current status of a live performance at an event venue; and provide a plurality of event-venue related services at the concierge devices, the event-venue related services being selectable based upon input from the attendee. At least one of the event-venue related services provided comprise displaying supplemental information using the electronic display based upon the location information associated with the concierge device, and the supplemental information is based upon the real-time performance information.

According to some other aspects, there is provided a computer-implemented method for providing concierge services. The method includes receiving location information indicative of locations of a plurality of concierge devices in an event venue; receiving real-time performance information about a live performance at the event venue; communicating with a plurality of concierge devices, each of the concierge devices being coupled to a seat in the event venue; and providing a plurality of event-venue related services at the concierge devices, the event-venue related services being selectable based upon input from the attendee. The at least one of the event-venue related services provided comprise displaying supplemental information using the electronic display based upon the location information associated with the concierge device and the supplemental information is based upon the real-time performance information.

### BRIEF DESCRIPTION OF THE DRAWINGS

Some embodiments will now be described, by way of example only, with reference to the following drawings, in which:

FIG. 1 is a schematic diagram illustrating a system for provisioning services in an event venue;

FIG. 2 is a schematic diagram illustrating a number of concierge devices mounted to some of the seats shown in FIG. 1;

FIG. 3a is a schematic diagram illustrating various hardware components of the concierge device shown in FIGS. 1 and 2;

FIG. 3b is a schematic diagram illustrating various modules that may be provided by the server and the concierge devices shown in FIG. 1 to provision a number of services;

FIG. 4 is a flowchart illustrating a method for providing concierge services at event venues according some embodiments;

FIG. 5 is an exemplary interface that may be provided the concierge devices according to the system and/or method of FIG. 1 and FIG. 4 respectively;

FIG. 6 is another exemplary interface that may be provided the concierge devices according to the system and/or method of FIG. 1 and FIG. 4 respectively;

FIG. 7 is another exemplary interface that may be provided the concierge devices according to the system and/or method of FIG. 1 and FIG. 4 respectively;

FIG. 8 is another exemplary interface that may be provided the concierge devices according to the system and/or method of FIG. 1 and FIG. 4 respectively;

FIG. 9 is another exemplary interface that may be provided the concierge devices according to the system and/or method of FIG. 1 and FIG. 4 respectively; and

FIG. 10 is another exemplary interface that may be provided the concierge devices according to the system and/or method of FIG. 1 and FIG. 4 respectively.

### DESCRIPTION OF SOME EMBODIMENTS

For simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments generally described herein.

Furthermore, this description is not to be considered as limiting the scope of the embodiments described herein in any way, but rather as merely describing the implementation of various embodiments.

In some cases, the embodiments of the systems and methods described herein may be implemented in hardware or software, or a combination of both. In some cases, embodiments may be implemented in one or more computer programs executing on one or more programmable computing devices comprising at least one processor, a data storage device (including in some cases volatile and non-volatile memory and/or data storage elements), at least one input device, and at least one output device.

In some embodiments, each program may be implemented in a high level procedural or object oriented programming and/or scripting language to communicate with a computer system. However, the programs can be implemented in assembly or machine language, if desired. In any case, the language may be a compiled or interpreted language.

In some embodiments, the systems and methods as described herein may also be implemented as a non-transitory computer-readable storage medium configured with a computer program, wherein the storage medium so configured causes a computer to operate in a specific and predefined manner to perform at least some of the functions as described herein.

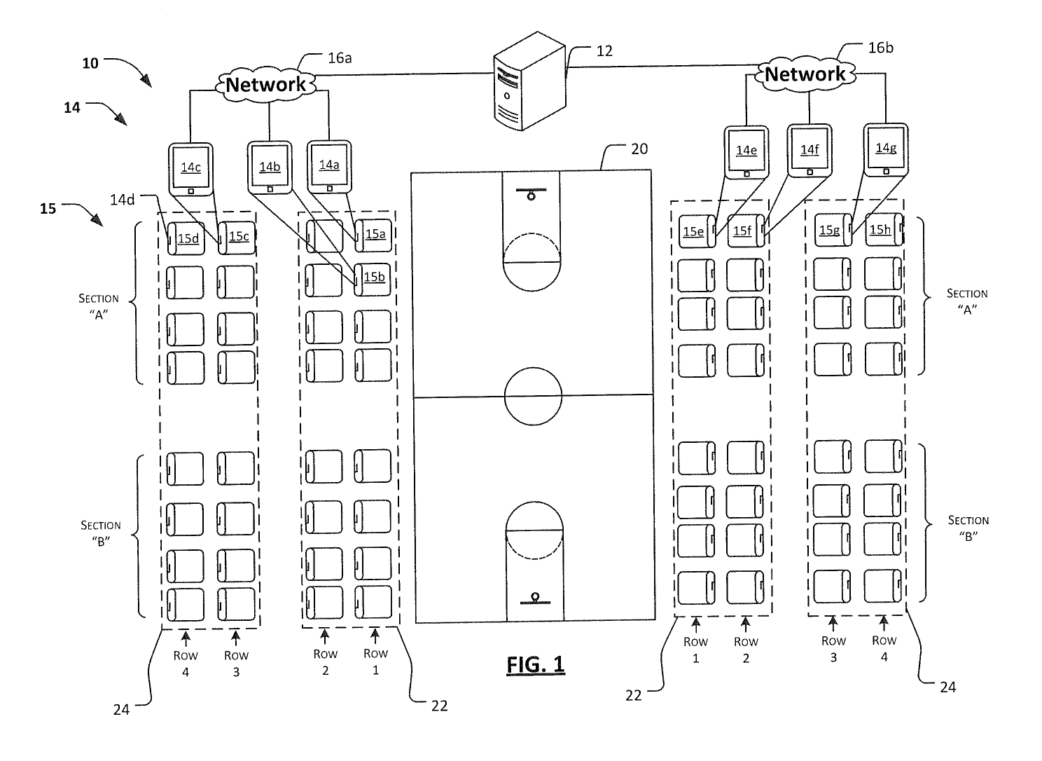

Referring now to FIG. 1, illustrated therein is a system 10 for provisioning services in an event venue according to some embodiments. The system 10 as shown includes a server 12 and a plurality of electronic concierge devices 14, which are in data communication with the server 12 via the wireless networks 16a and 16b.

The event venue could be a stadium, arena, conference centre, classroom, lecture room or other type of suitable venue for hosting a plurality of spectators for one or more live performances. The live performances may include sports games, musical or entertainment performances, motivational speakers, charity events, and so on. In the embodiment as shown, the event venue is configured to host a basketball game as indicated by the basketball court 20. The live performance in the current example may be any activity that takes place on the court 20, including the basketball game, time-out performances, quarterly break performances and a halftime performance.

The event venues generally have a plurality of seats 15 to accommodate a number of spectators. In the event venue shown in FIG. 1, there are four rows of seats 15 on each side of the court. Each row is further divided into two sections, namely section “A” and section “B”. It should be understood that this seat configuration is only for illustrative purposes. In other cases, various event venues may configure the seats in various ways for various reasons. The number of seats may be in thousands or tens of thousands. Seat configuration may also change depending on the live performance that is being hosted. For example, seat configuration for a concert may be different from a seat configuration for a basketball game.

The price of each of the seats may reflect the location of the seat relative to the performance. In many venues, the seats could be grouped together based upon one or more characteristics of the seats. For example, seats may be grouped together based location of the seats. In the case of a professional basketball game, courtside seats may be grouped together, followed by side-line seats, end-line seats, and so on. In the example as shown, the first two rows of seats on either side of the court are grouped together as platinum seats 22. The third and fourth row seats are grouped together as gold seats 24.

In some embodiments, the concierge devices 14 could be mounted on backs of a plurality of seats such that the devices are accessible to spectators occupying the seats behind the mounted seats. As shown, there are concierge devices 14 mounted on back of some of the seats 15. More specifically, the concierge device 14a is mounted to the back of seat 15a, concierge device 14b to the back of seat 15b and concierge device 14c to the back of seat 15c and the concierge device 14 d to the back of seat 15d on one side of the court. On the other side of the court, the concierge devices 14e, 14f, 14g are mounted to the back of the seats 15e, 15f, and 15g respectively.

In the layout as shown, the spectator occupying the seats in a row behind the seats where the concierge devices 14 are mounted on will have access to these devices. For example, spectators in Row 2 seats behind seats 15a and 15b will have access to the concierge device 14a and 14b respectively. Similarly, the spectator in seat 15f will have access to the concierge device 14e and so on. The spectators may use the concierge devices 14 to access the server 12 and the server 12 may communicate to these spectators through the concierge devices 14. It should be understood that while only concierge devices 14a-14c, and 14e-14g are shown connected to the server 12, the other concierge devices 14 (such as the concierge device 14d) which are mounted at back of seats 15 are also connected to the server 12.

The concierge devices 14 may be mounted to the back of the seats in different ways. For example, the concierge devices could be mounted to the back of the seats using a hardware bracket. In other examples, the concierge devices could be embedded in the back of a seat such that a display screen of the concierge device is generally coplanar with a back outer surface of the back of the seat. In other embodiments, the concierge devices may be mounted at parts of the seats other than seatbacks. For example, the concierge devices may be mounted at headrests of the seats or any other suitable parts of the seats. In other embodiments, the concierge devices provided at the seats may be mounted to structures other than seats in the event venue (e.g. concierge devices made available to the occupants of ROW 1 seats may be mounted to structures other than seats). In some cases, the concierge devices may not be presented in the first row of the seat. In some cases, the concierge devices may be located under the seat.

In some embodiments, the concierge devices may be provided at locations other than the seats throughout the stadium. For example, the concierge devices may be provided at standalone kiosks at a concourse level. This may help alleviate concession traffic in stadiums. For example, rather than waiting in line for 15 minutes to order a hot dog and beer at busy outdoor stadiums, a customer could simply order at a kiosk (self-serve) and receive a prepaid ticket and return to his/her seat where the order would be delivered. The prepaid ticket could be presented to the person delivering the order to complete the sale.

Generally, as the seats in each row may be elevated above the preceding row to improve visibility (e.g. seats in Row 2 may be higher than seats in Row 1, Row 3 higher than Row 2, and so on), it may be difficult for the spectator in one of the seats to view the display of the concierge devices mounted at the seat back of the seat in preceding row. In some cases, the angle of display screen of the concierge devices relative to the axis of the plane of the seatback may be adjustable to improve viewing from a higher vantage point. In some cases, the display screen may be tilted upwards at an angle to reduce glare to the spectator using the concierge device. In some embodiments, the angle may be tilted at 60 degrees.

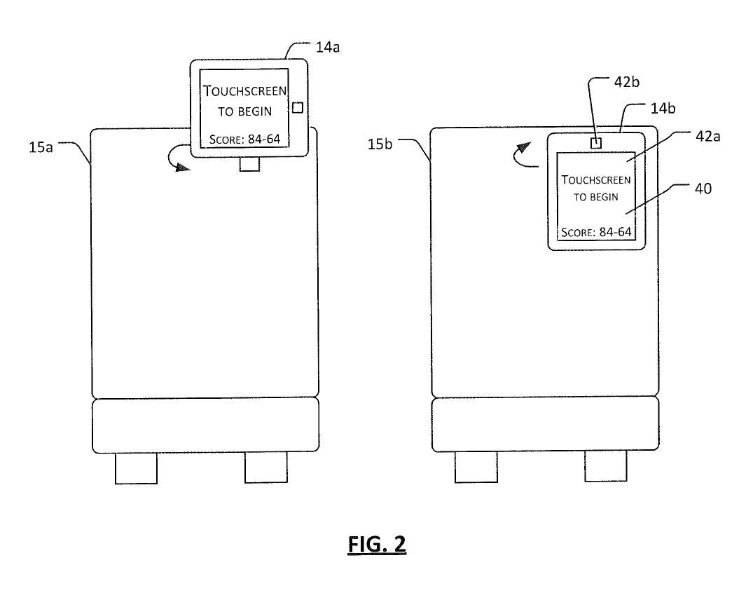

Referring now to FIG. 2, illustrated there is a back view of two of the seats 15a and 15b shown in FIG. 1. FIG. 2 also illustrates a rotatable mounting of the concierge devices 14a and 14b to the seats 15a and 15b according to some embodiments. The mounting hardware in FIG. 2 allows the concierge device to be rotated to a higher position such that the concierge device may be more conveniently accessible to the spectator in the elevated seat in the next row. As shown, the concierge device 14b is in a first position where the concierge device is no higher than the back of the chair such that the spectator's view of the live performance is not impeded by the concierge device 14. In contrast, the concierge device 14a is in a second position which places the concierge device at a higher level that may impede the spectator's view of the live performance but may allow more convenience access to the concierge device 14. In other embodiments, the concierge devices may be movable between the first and second positions via means other than rotating the concierge device (e.g. sliding).

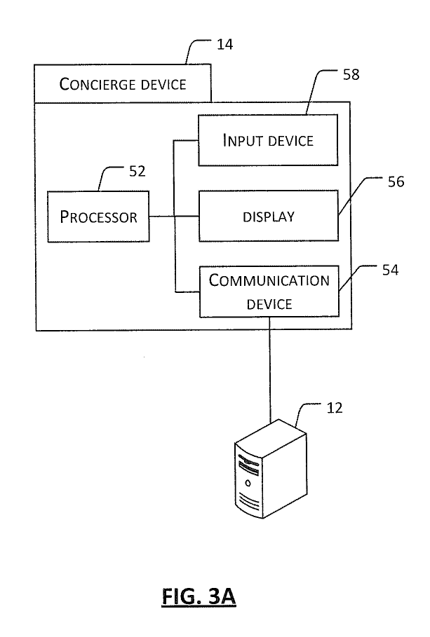

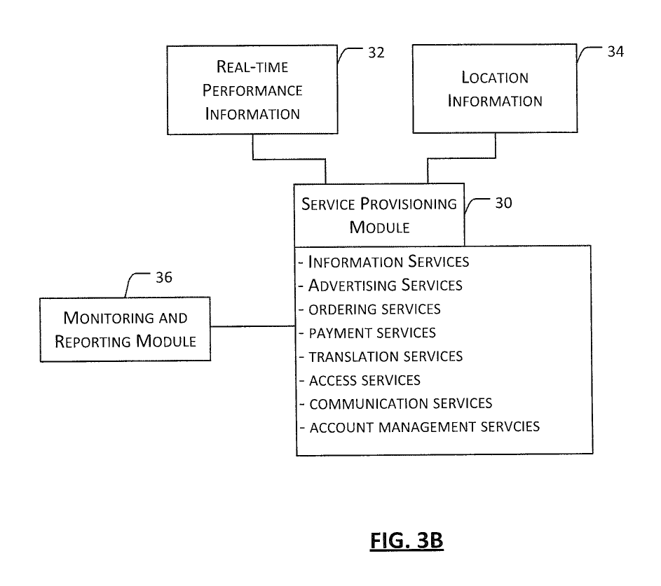

Referring now to FIG. 3A, each of the concierge devices 14a-14n includes at least one processor 52 in data communication with the server 12. For example, the concierge device may include wireless communication hardware 54 that can communicate with the server 12 via a wireless or wired network. In some cases, an IEEE standard 802.11 compliant network (“wi-fi”), for example, the network 16a and 16b may be used to facilitate communication between the concierge devices 14 and the server 12. Each of the concierge devices 14 also includes a display device 56 and an input device 57 coupled to the at least one processor 52. In some cases, the display device 56 and the input device 58 may be implemented using a touchscreen input device such as a capacitive touchscreen that is capable of displaying information to the users and receiving input from the users. For example, the concierge device 14b includes a display 40 that also works as a touchscreen 42a for receiving input. The concierge device also includes a secondary input in a button 42b. Each of the concierge devices 14 may also include a gyroscope for detecting the orientation of the concierge device. As shown, the concierge device 14a is in a landscape format while the concierge device 14b is in a portrait format. The gyroscope detects the current orientation of the concierge device so that the information being displayed on the display could be oriented suitably.

In some embodiments, for some sections, the concierge devices 14 may be provided in common areas associated with those sections. The spectators may access the concierge devices to obtain selected services. For example, the spectators may order food using these concierge devices and have the food delivered to their seat. In some embodiments, the concierge devices may scan a spectator's tickets to determine a location where the food should be delivered.

The concierge devices, in some embodiments, may be implemented using commercially available tablet-form computing devices. For example, the concierge devices may implemented using an iPad™ tablet marketed by Apple Inc. or a tablet running Android™ operating system.

Each of the concierge devices 14 is associated with location information indicative of a physical location of the device within the event venue. The location information of each of the concierge devices 14 could be determined in different ways. For example, the location information of the concierge device may be determined from an access point within the stadium being used by the concierge device to communication with the server 12. In other cases, the location could be determined by associating a unique device ID with the location information for that concierge device. For example, an MAC address, IP address, or other suitable form of unique identifier could be associated with a seat number of the seat that normally accesses the concierge device.

In some cases, the location information of a plurality of the concierge devices could be grouped together. For example, the location information may indicate that a concierge device is being associated with platinum seats 22 or the gold seats 24. This allows the system 10 to provision additional services via different groupings to improve user experience for the customers of these seats. In some cases, this may also allow the system 10 to provide different levels of services to different groups of seats. For example, the platinum seats 22 may have access to more services than the gold seats 24.

In some cases, one or more of the users may enter or may be required to enter a user identifier and a password to identify and authenticate him/herself to the server 12. For example, season ticket holders or regular attendees at events may wish to set up an account with the system 10 to obtain more personalized service. Having an account may also prevent the account holder from having to re-enter payment information each time the account holder is tendering a payment. In some cases, the system 10 may provide promotional information (e.g. electronic discount coupons, or targeted messages) to select users with user accounts within the system 10.

The server 12 includes at least one server processor and one or more storage devices (not shown) coupled to the server processor. The at least one of the data storage devices may store computer-executable instructions which may be accessed and executed by the server processor to provide the functionalities described herein.

The server 12 has real-time performance information about a live performance at the event venue. The real-time performance is indicative of the activity in the performance at that time such as what the performers are doing or what the performance is about at that time. The real-time performance information, for example, may include information about what the performer is doing at a given moment such as singing a certain song, performing a certain act, presenting about a certain topic, and so on. In the case of a sports game, real-time information may include whether the game is current halted due to a time-out, scheduled breaks between game periods and so on.

It should be understood that real-time performance information is not necessarily an instantaneous reflection of the live performance. There may be a time delay in the information that is induced from various system or human limitations such as transmission delays between the server 12 and the source of the real-time performance information. In some cases, real-time information may be briefly delayed intentionally, for example, to allow censoring of undesirable words or actions.

The server 12 and the concierge devices use the real-time performance information, location information or combination thereof to provide one or more services as described below. Referring now to FIG. 3b, illustrated therein are various exemplary modules that may be implemented by the processor(s) in the server 12, the concierge devices 14, or a combination thereof to provide the services described below.

As shown, the service provisioning module 30 receives real-time performance information from a real-time performance information module 32. In some cases, the real-time performance information module 32 may be configured to obtain the real-time performance information automatically from in-venue electronic system. For example, the real-time performance information may be received from the scoreboard or the game clock. In some cases, the real-time performance information may be received from the audio/video (“A/V”) system being used for the live performance. In some cases, real-time performance information may be provided based upon input by an operator, who, for example, may be the A/V personnel at the venue.

As shown, the service provisioning module 30 also receives location information associated with the concierge devices 14 from the location information module 34. The location information 34, as noted above, is indicative of the location of the concierge device. In some cases, the location information may be provided by the concierge devices requesting the services. In some cases, the location information may be determined by the location information module 34 based upon some information (e.g. device ID, MAC address, IP address) provided by the concierge devices.

The service provisioning module 30 uses the location information, the real-time performance information or a combination thereof to provide one or more services to that concierge device.

In some cases, the service provisioning module 30 may be implemented using both the concierge devices 14 and the server 12. For example, an advertisement video/presentation that is scheduled to be played during the game break between the third and fourth quarter of a basketball game may be preloaded on to the concierge device. The server 12, based on real-time performance information may send a command to the concierge devices at the selected locations at the appropriate time to present the advertisement. In such cases, since the advertisement is pre-loaded (i.e. pre-“cached”) on the concierge devices, it will not be necessary to stream this information over the wireless network when it is presented on the concierge devices.

In some cases, the concierge devices 14 may be controlled by the server. The concierge devices 14 may be configured to be “slaves” to the server 12. In such cases, the servers 12 may dictate the services provided at different concierge devices based on real-time performance information. For example, the server 12 may dictate what services to provide to what concierge devices 14 based on real-time performance information.

In some cases, instead of the server 12 controlling the concierge devices 14, the server 12 may forward the real-time performance information to the concierge devices 14. The concierge devices 14 may be configured to provide services based upon the received real-time performance information without further input from the server 12.

The services provided by the service provisioning module 30 may include providing information to the users based upon location information and/or real-time performance information.

In some embodiments, the services provided may include providing information to the concierge devices 14 based upon location information and/or real-time performance information.

The information provided may include commercial and/or advertising information. For example, advertisements may be delivered to the concierge devices 14 based on real-time performance information (e.g. during a time-out in a sports game or a scheduled break of the performance). The advertisements may also be tailored specifically to each concierge device 14 and/or each group of concierge devices 14. In other words, the system 10 may provide different advertisements to different concierge devices 14 based upon the location of the concierge devices 14. For example, users in premium seats may be provided with different advertisements than the users in less expensive seats.

In some embodiments, advertisements may be provided based upon real-time performance information such as the game clock. In some embodiments, the advertising information may be provided continuously. For example, there may be a relatively small banner that is displayed across various menu options. In some cases, the size of the advertisement being displayed may differ based upon real-time performance information. For example, the size of the advertisements may be increased (e.g. to full screen) during a time-out or other non-scheduled breaks.

In some embodiments, the information provided may include game day programs. This may replace hardcopies of game day programs that are traditionally produced and sold at various games. In some embodiments, there may be a charge for accessing electronic game day programs using the concierge devices 14. In some embodiments, the users of the concierge devices may transmit the game day programs to designated addresses such as the users' personal email accounts, or other electronic addresses.

The information provided may also include information that may supplement the live performance. For example, when the event is a musical performance, the event related information may include information such as song lyrics of the song that is currently being performed, discography, biographical information of the artist, and so on. Similarly, if the performance is a presentation or a motivational event, then the information may include supplemental information such as presentation slides or other relevant information. In some cases, the concierge devices may be configured to receive user feedback. For example, the performer may poll the users via the concierge devices.

In another example, the services provided may include closed captioning services. In some cases, the services provided may include access services such as various forms of assisted communication to help disabled or hearing impaired spectators. In some cases, the concierge devices may provide translations to various languages.

In another example, if the live-performance is a sports game, the concierge device 14 may display additional information related to the players in the game. For example, the concierge device 14 may provide statistical information about the player's current performance and historical performance. The concierge device 14 may also be configured to provide various rankings, standings, or even information about other games in the same league.

The concierge device 14 may also provide a live audio and/or video broadcast (i.e. a live stream from television or radio coverage) to supplement on-court live action. For example, the concierge device may allow a user to view a TV broadcast of the game, which may provide benefits of a TV production such as replays, TV commentators and the like. In another example, the concierge device may allow a user to listen to a radio broadcast of the event, which may be advantageous as radio commentary is generally more descriptive and comprehensive than the in-venue announcers. The users may also provide feedback such as voting for “player of the game” using the concierge devices 14.

In another example, the information provided by the concierge device 14 may include directory information related to the venue. The directory information may be presented and oriented based upon location information of the seat. This may allow the user in the seat to more easily locate facilities that are around him/her.

In some cases, the concierge devices 14 may be configured to allow the users to forward selected information that are being provided to the concierge devices such that the user may save and review the information at a later time. For example, the information could be forwarded to an email address designated by the user.

In some embodiments, the services provided by the service provisioning module 30 may include ordering services. For example, the concierge device 14 may be configured to allow a user to order food (including beverages) or merchandise from his/her seat. The order may include location information about the seat where the order was placed and this location information could be used to deliver the order to the seat. In some cases, the venue may feature an express order pick-up location (e.g. a dedicated line at the restaurant) for individuals who had placed orders from their concierge devices 14. This may allow the venue to provide satisfy received orders more efficiently and the spectators to receive their orders without long line-ups. In some cases, where there are multiple express order pick-up locations, the location information about where the order is received from may be used to assign an express order pick-up location for that order.

In some cases, the concierge devices 14 and/or the server 12 may be configured to receive reservations to rent accommodation in or nearby the venue, or luxury suites in or nearby the venue. The concierge devices 14 may allow the users to check availability of such rental property, reserve and pay for such rentals at their seats.

The services provided by the service provisioning module 30 may also include processing payments at the concierge devices 14. For example, the concierge device 14 may allow a spectator to supply payment information such as credit card information to process various payments, such as payments for costs of ordering merchandise or food products. In some cases, the payment processing services may also be used in connection with the real-time performance information. For example, if the performance solicits donations from the spectators and the payment processing services may be made available when such a request is made during the performance based upon real-time performance information.

In some embodiments, the concierge devices 14 may include a card reader for reading identification and/or payment cards. The card reader may be used to process payment via various types of payment cards (e.g. debit, credit, charge, etc.). In some cases, the card reader may also read identification cards such that the system is able to verify that the order is being received in connection with an identification card that indicates legal age to order alcoholic beverages.

In some embodiments, the services provided by the service provisioning module 30 may social media and communication services. For example, the concierge devices 14 may facilitate communication between the performer/even organizer to the spectator at the seat. In some cases, the performers may wish to deliver real-time communication to the concierge devices 14 at certain locations. For example, a basketball player may wish to share his thoughts with fans who are season ticket holders while he is not on the floor playing such as when there is a break in the game or when he is benched. In such a case, the player may send instant communication to the concierge devices 14 associated with the seats that are sold to season ticket holders. This may allow the sports team to provide a more intimate level of service to a selected group of attendees.

In some cases, the communication may occur between spectators sitting at different seats. For example, a person sitting in a first seat may wish to communicate with a person sitting in a second seat across the stadium. The system 10 may facilitate the communication between different seats based on location information. For example, the user may communicate to another person based upon location of the seat that the other person is occupying.

In some embodiments, the concierge devices 14 may be configured to connect to and communicate with personal electronic communication devices brought into the venue by the spectators. For example, the spectator may bring in a smart phone, an electronic personal digital assistant (PDA). However, as such personal electronic communication devices often have smaller sized display screens, the spectators may wish to view the information from the personal electronic devices on the display of the concierge devices 14. The concierge devices 14 may be configured to communicate with the personal electronic devices to receive information from the personal electronic devices and display that information on the display of the devices 14. Bluetooth or other form of suitable wireless or wired communication may be used to facilitate data exchange between the concierge devices 14 and the personal electronic devices brought in by the spectators.

In some embodiments, the services provided may include account management services for season ticket holders. The concierge devices 14 may allow a season ticket holder to review and/or make various changes to the user's season ticket account.

In some embodiments, the server 12 may be configured to track usage information for the concierge devices 14 including the location information and real-time performance information. In the embodiment as shown, a reporting module 36 is configured track and report usage information for the concierge devices 14. This information may be used to generate reports or to devise new marketing strategies. For example, a marketing report based on usage patterns might reveal that spectators in platinum seats (i.e. location information) are most likely to order drinks during the second and third quarters of a basketball game (i.e. real-time performance information). In response to such a report, the operator of the stadium may wish to reallocate resources accordingly to meet increased demand at the location at the time, and/or provide targeted advertisements.

The usage information may be collected for individual seats, group of seats, user account and so on. This data may be used to design and implement more effective advertising campaigns.

Various embodiments of the system 10 may be used to generate novel revenue streams or improve existing revenue streams. For example, it may be possible to sell advertising to be presented at the concierge devices. Furthermore, the advertising could be targeted based upon location, interactive and/or delivered based upon real-time performance information. These features may allow the advertising to be more effective as advertisement could be tailored and delivered when the user is not distracted by the live performance. This form of advertising may command a premium advertising fees due to its effectiveness.

Various embodiments of the system 10 may also improve revenues from food and merchandise sales as the system 10 makes it easier for users to place and/or process payment on orders. For example, the users may place orders without leaving their seats. In some cases, the promotional messages provided to the users at appropriate locations and appropriate time may further encourage the users to place orders for food or merchandise. The system 10 may also reduce operational costs associated with food and merchandise orders as usage patterns may be monitored to allocate resources more effectively.

The operator of the event venue may also charge performers to use various services provided by the system 10. For example, a commission may be charged for orders for the performers products received through the system 10 or for displaying their discography or credits.

Various embodiments of the system 10 may allow the organizers/operators to connect with the spectators directly to provide additional levels of service. This may improve overall customer satisfaction with the event venue and/or the performance. In some cases, additional services may be provided as a “perk” to spectators who are in selected seats (i.e. those in premium higher priced seats). This may allow spectators in such seats feel like they are being treated as VIPs. For example, athletes may be prompted to send periodic communication messages to season ticket holders in platinum level seats. This may allow the spectators in those seats to feel like they are more connected to the team. Similarly, other performers may communicate real-time with spectators in selected locations.

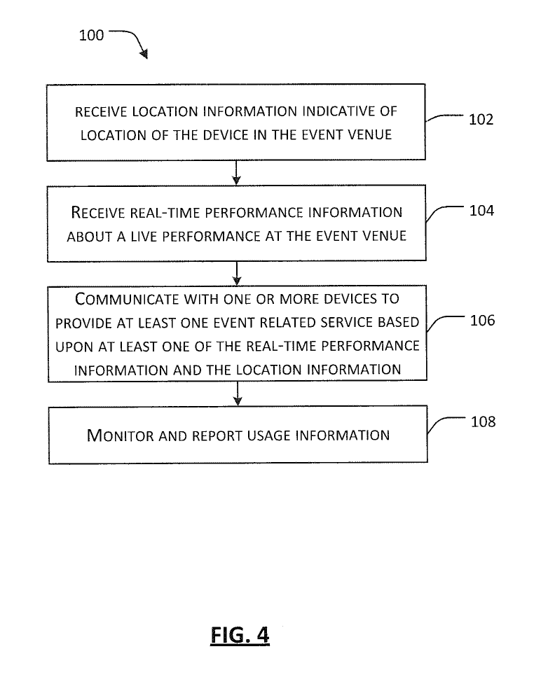

Referring now to FIG. 4, illustrated therein is a method 100 for providing concierge services in live-performance venues according to some embodiments. One or more of the steps of the method 100 may be executed by a processor on a server such as the server 12. The method 100 starts at step 102.

At step 102, location information indicative of location of a plurality of concierge devices in the event venue is received. In some embodiments, this step may include determining the location information, for example, based upon the IP address, access point, and/or unique identifier associated with the concierge device.

At step 104, real-time performance information about a live performance at an event venue is received using the wireless communication device. The real-time performance information may be similar to or the same as the real-time information described above in connection with the system 10. The real-time information, for example, may include information about what the performer is doing at a given moment such as singing a certain song, performing a certain act, presenting about a certain topic, and so on). In cases of sports game, real-time information may include whether the game is current halted due to a time-out, scheduled breaks between game periods and so on.

At step 106, the processor in the server communicates with one or more of the concierge devices to provide at least one service based upon at least one of the real-time performance information and the location information.

At step 108, concierge device usage information is monitored to generate various reports. Reports generated may include how much revenue is generated as well as the location information and real-time performance information of where and when the revenue is generated.

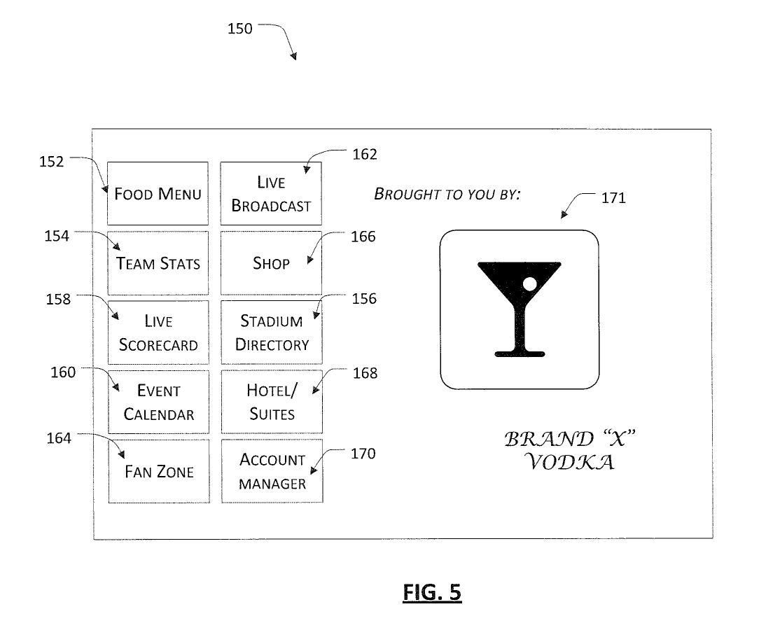

Referring now to FIGS. 5-10, illustrated therein are various exemplary interfaces that may be presented at the concierge devices to provide services based upon at least one of the location information and the real-time performance information.

An exemplary welcome menu 150 is illustrated in FIG. 5. The audiences may interact with one or more of the menu options 152 to access related services. The services accessible through this menu 150 includes food ordering services 152, information on team rosters and statistics 154, stadium directory 156, a live scoreboard 158, an event calendar 160, a live audio broadcast 162, an interactive forum 164, merchandise ordering service 166, hotel and luxury suit rentals 168 and an account manager 170 for season ticket holders. As shown, the system may also show advertisement 171, which in this case is for “Brand X Vodka”.

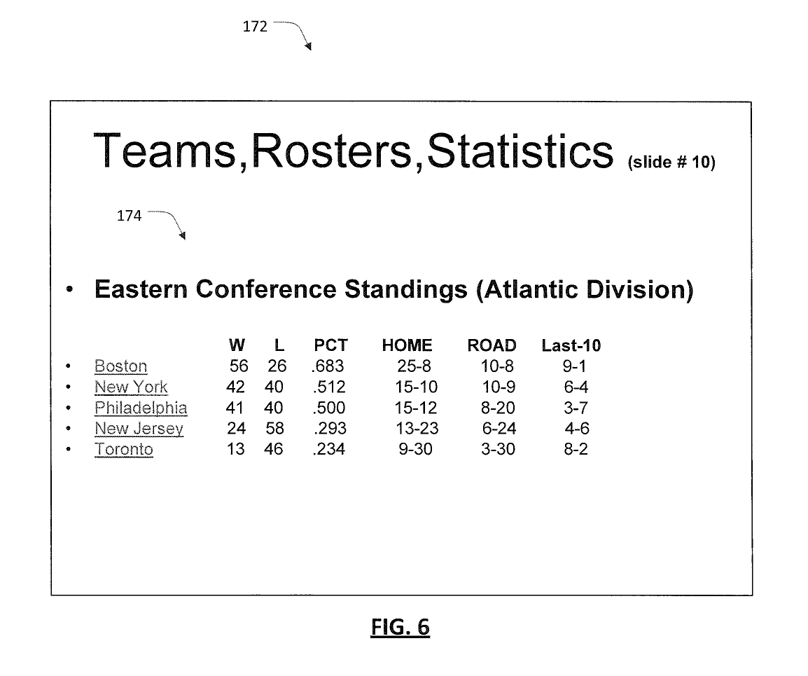

Exemplary supplemental information screen 172 providing supplemental information about a sports league is shown in FIG. 6. The information provided includes information 174 about various teams in the Eastern Conference of a sports league.

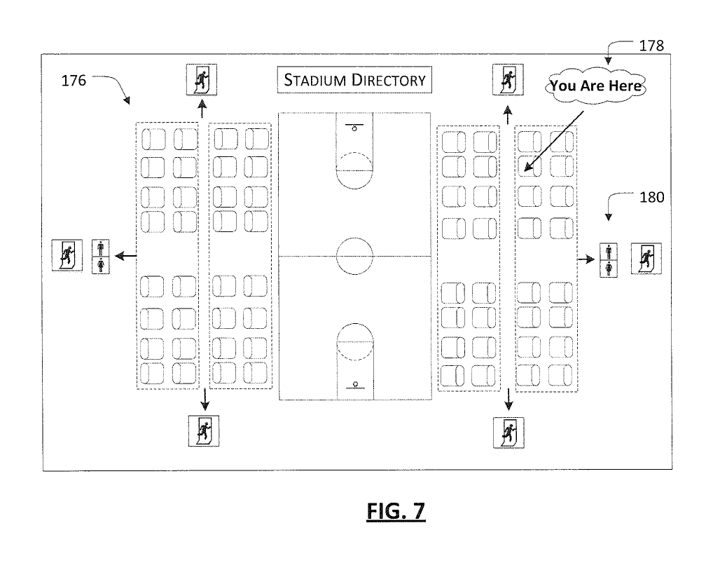

An exemplary stadium directory 176 that may be provided by the concierge device is shown in FIG. 7. Based on location information, the directory 176 indicates the current location 178 of the concierge device accessing the directory and indicates exists and bathroom facilities 180 that are located near the location 178. In some embodiments, the directory may allow a user to zoom in and zoom out of the map, and to search for different facilities within the event venue.

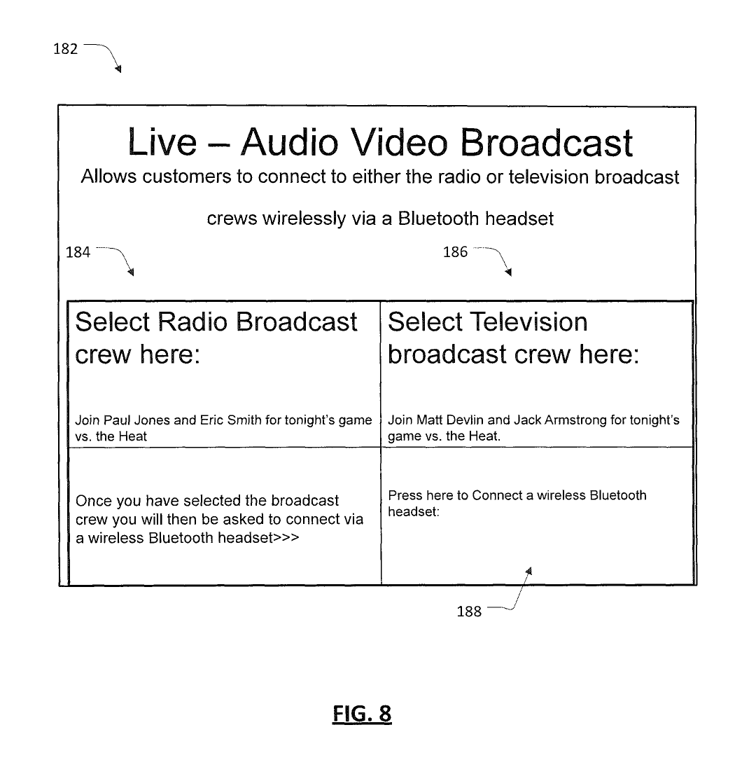

Referring now to FIG. 8, illustrated therein is a menu for accessing live audio and video broadcasts that may be provided by the concierge devices. A user may select to listen to radio broadcast 184 or to watch a television broadcast 186. A wireless headset may be paired with the concierge device via Bluetooth wireless network option 188 to wirelessly transmit the audio to the headset. These services may make the game more accessible to handicapped abled attendees (e.g. fans who are hard of hearing). In some cases, the options may also provide the spectators to watch an instant replay of the live performance.

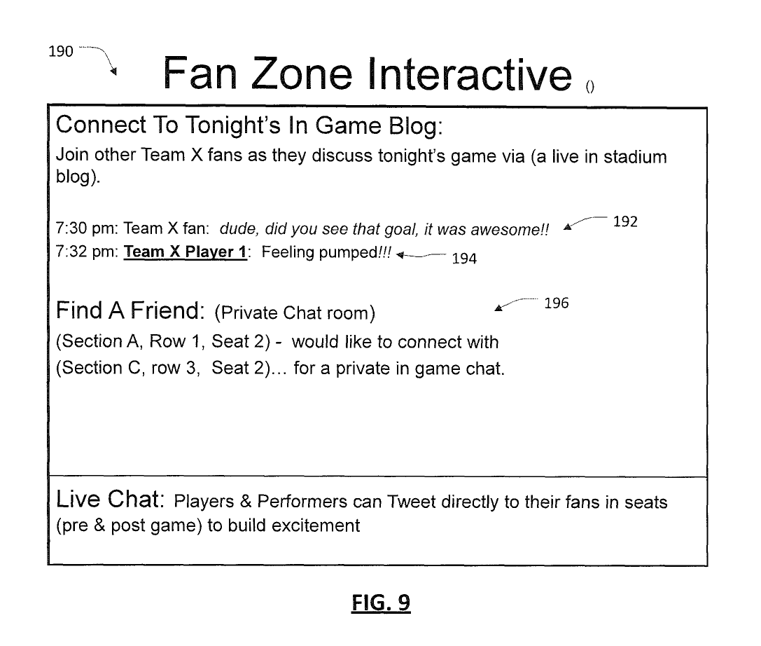

Referring now to FIG. 9, illustrated therein is an exemplary interface 190 showing live communication between spectators and performers. A message 192 is shared by a fan while a message 194 is shared by a player of a team. In addition to the public chat, a private room 196 between various occupants of seats based upon location of the seats is also facilitated.

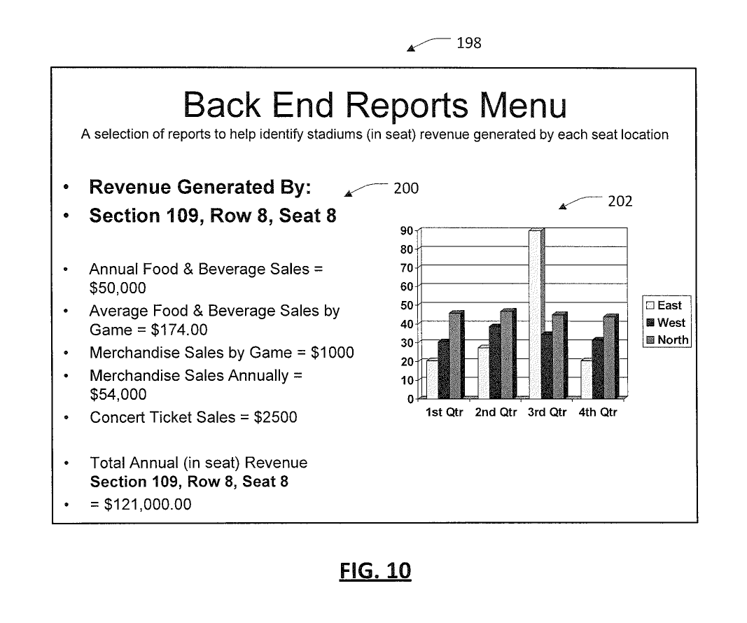

Referring now to FIG. 10, illustrated therein is an exemplary report 198 including information 200 about revenue generated by a certain seat. The report also includes a graph 202 illustrating which grouping of seats (East/West/North) generates most revenue and when (1^{st}, 2^{nd}, 3^{rd} or 4^{th} quarter) that revenue is generated. It should be understood that other reports illustrating other aspects of the revenue may also be presented.

While the above description provides examples of one or more apparatus, systems and methods, it will be appreciated that other apparatus, systems and methods may be within the scope of the present description as interpreted by one of skill in the art.

The inventors claim systems and methods having one or more of the elements as generally described herein including the following claims.

1. In-venue concierge system comprising:
(a) a server configured to receive real-time performance information indicative of a current status of a live performance at an event venue having a plurality of seats; and
(b) a plurality of concierge devices in data communication with the server, each of the concierge devices being coupled to one of the plurality of seats and being associated with location information indicative of a location of the seat, each of the concierge devices having an input device for receiving input from a spectator at the live performance;
(c) wherein the server and the concierge devices are configured to provide a plurality of event-venue related services at the concierge devices, the event-venue related services being selectable based upon input from the attendee, and wherein at least one of the event-venue related services comprises displaying supplemental information at the concierge devices based upon the location information associated therewith, the supplemental information being based upon the real-time performance information.

2. The system of claim 1, wherein the supplemental information displayed includes at least one message from personnel associated with the live performance.

3. The system of claim 2, wherein the at least one message is recorded during the performance.

4. The system of claim 2, wherein the at least one message is displayed at the concierge devices in real-time.

5. The system of claim 2, wherein the at least one message is displayed at selected concierge devices, the devices being selected based upon the location information associated therewith.

6. The system of claim 1, wherein the supplemental information provided at the concierge devices is differentiated based upon location information associated with the devices.

7. The system of claim 1, wherein the supplemental information provided at the concierge devices is differentiated based upon real-time performance information.

8. The system of claim 1, wherein the supplemental information includes advertising.

9. The system of claim 1, wherein the supplemental information includes a media broadcast of the live performance.

10. The system of claim 1, wherein the supplemental information includes accessibility information to promote access to the live performance.

11. The system of claim 1, wherein the input device is operable to solicit input from the attendee based upon the current status of the live performance.

12. The system of claim 1, wherein the input device is operable to solicit input from the attendee on-demand.

13. The system of claim 11, wherein the received input is associated with the location information of the concierge device from which the input is received.

14. The system of claim 1, wherein the event-venue related services include receiving at least one order for a product or a service, the received order being associated with the location information of the concierge device from which the order is received.

15. The system of claim 1, wherein the event-venue related services include accepting payment from a user.

16. The system of claim 1, wherein at least one of the concierge devices includes a wireless communication device for communicating with a portable electronic device.

17. The system of claim 1, wherein at least one of the seats include a headrest and one of the concierge devices is mounted to the headrest.

18. The system of claim 1, further comprising mounting hardware for coupling the concierge device to one of a plurality of seats in the event venue.

19. The system of claim 16, wherein the concierge device includes a display and the mounting hardware includes an adjustable mechanism to adjust an angle of the display device.

20. The system of claim 1, wherein the server is further configured to track usage information of at least one of the concierge devices and associate that usage information with at least one of the real-time performance information and the location information.

21. An electronic concierge device comprising:
(a) an electronic display;
(b) an input device for receiving input from a user;
(c) a communication device; and
(d) a processor coupled to the electronic display, input device and the communication device, the processor having location information indicative of a location of the concierge device and being configured to:
(i) communicate with a server via the communication device, the server having real-time performance information indicative of a current status of a live performance at an event venue,
(ii) provide a plurality of event-venue related services at the concierge devices, the event-venue related services being selectable based upon input from the attendee, and
(iii) wherein at least one of the event-venue related services provided comprises displaying supplemental information using the electronic display based upon the location information associated with the concierge device, the supplemental information being based upon the real-time performance information.

22. A computer-implemented method for providing concierge services, the method comprising:
(a) receiving location information indicative of locations of a plurality of concierge devices in an event venue;
(b) receiving real-time performance information about a live performance at the event venue;
(c) communicating with a plurality of concierge devices, each of the devices being coupled to a seat in the event venue;
(d) providing a plurality of event-venue related services at the concierge devices, the event-venue related services being selectable based upon input from the attendee; and
(e) wherein at least one of the event-venue related services provided comprise displaying supplemental information using the electronic display based upon the location information associated with the concierge device, the supplemental information being based upon the real-time performance information.
